(19) United States
(12) Patent Application Publication
(10) Pub. No.: US 2026/0034003 A1
(43) Pub. Date: Feb. 5, 2026

(54) MOBILE HOSPITAL BED HEADBOARD WITH PATIENT USE TRAYS, INTEGRATED POWER, AND LOCATION TRACKING

(71) Applicant: Guy Aristide, East Meadow, NY (US)

(72) Inventor: Guy Aristide, East Meadow, NY (US)

(21) Appl. No.: 19/355,308

(22) Filed: Oct. 10, 2025

Related U.S. Application Data
(63) Continuation of application No. 18/416,394, filed on Jan. 18, 2024, now Pat. No. 12,458,552.
Application No. 18/416,394 is a continuation of application No. 17/856,323, filed on Jul. 1, 2022, now Pat. No. 11,911,326.
Application No. 17/856,323 is a continuation of application No. 17/140,038, filed on Jan. 1, 2021, now Pat. No. 11,406,547.

(51) Int. Cl. A61G 7/05

(52) U.S. Cl. CPC A61G 7/0506; A61G 7/0503

(57) ABSTRACT

In one example, a hospital bed headboard is disclosed. The hospital bed headboard includes a planar multiple paneled headboard. The planar multiple paneled headboard includes a first panel and a second panel, each with a cavity, that can pivotally attach to corresponding supports and are configured to swing open inwardly toward a patient supported by the mobile hospital bed to provide an egress area. Each cavity houses a foldable tray concealed within it that can swivel and open towards the patient. The hospital bed also includes a charging port to provide power to attached electronic devices and a GPS locator that allows location tracking for the hospital bed.

### CROSS-REFERENCE TO RELATED APPLICATIONS

This application is a continuation of U.S. patent application Ser. No. 18/416,394, filed Jan. 18, 2024 (now allowed), which is a continuation of U.S. patent application Ser. No. 17/856,323, filed Jul. 1, 2022, now U.S. Pat. No. 11,911,326, which is a continuation of U.S. patent application Ser. No. 17/140,038, filed Jan. 1, 2021, now U.S. Pat. No. 11,406,547, which are hereby incorporated by reference herein in their entireties.

### FIELD OF INVENTION

The present invention relates generally to an integrated hospital bed, and more particularly, to a hospital bed headboard that is planar, multipaneled, and adaptable for patient access, equipment support, and patient comfort during both transport and stationary care. The present invention also relates to enhanced functionality for patient use and transport logistics, including integrated charging capability, additional integrated bedside trays, and a tracking system.

### BACKGROUND

In many hospitals, patients often need to be transported from one hospital unit to another. As an example, a patient may need to be transported between the patient's room and an MRI (magnetic resonance imaging) unit where the patient can undergo an MRI scan. Or the patent may need to be transported to or from the ICU (intensive care unit) or the ER (Emergency Room).

The patient may be transported while lying on a mobile hospital bed. Medical equipment for the patient may be attached to the mobile hospital bed. The equipment may include ventilators, IV poles with multiple drips, monitors, Foley catheters, oxygen tanks, etc. Along with such equipment, moving the patient from one unit to another can be a harrowing experience for medical staff. Patient transport is a dynamic event requiring knowledge, skill, equipment, and communication. Transporting patients in the hospital and especially in the ICU is cumbersome, timely, leads to higher staff usage and impede care delivery for non-transport patients.

Medical equipment can be unwieldy and often calls for multiple staff to hold the medical equipment and to guide the mobile hospital bed. Sometimes, as many as five staff members are needed to move the patient often under hurried conditions that can be unsafe. IV lines and intubation lines with vital medication can be pulled out. Medical staff can also get hurt (e.g., back spasm) trying to navigate a medical hospital bed and equipment that is cumbersome.

High usage of staff, time and all of the attached equipment allows for many opportunities for errors and for harm to occur. Many mobile hospital beds also have a single standard headboard that is stationary and extends between the bedposts. If quick access to the patient becomes necessary during patient transportation, the single standard headboard may be an obstacle and may be the difference between life and death.

Beyond the challenges of transport, patients in a stationary or post-critical care setting require surfaces for daily activities, such as eating or placing personal objects. To meet this need, a separate, wheeled, movable bedside table is typically brought in. These tables are often large and hard to maneuver, especially in a crowded hospital room.

The design of these traditional bedside tables presents several problems. They do not always fit under the hospital bed, particularly if the bed is lowered, leaving insufficient space underneath. Furthermore, the maneuverability of these tables is often limited, making it difficult to easily adjust the table to a position of the patient's liking or based on the patient's body size so they can easily reach it. This causes patient discomfort and can require staff assistance just to reposition the table. The large size and separate nature of the table also complicate moving the patient and bed around the room, which can still be a necessity even in a stationary setting.

### SUMMARY OF THE INVENTION

In one example, a hospital bed headboard is disclosed. The hospital bed headboard may be planar and multiple paneled. In some examples, the hospital bed headboard may include a first panel positioned adjacent to a second panel. The first panel may open a right side of the hospital bed headboard and the second panel may open a left side of the hospital bed headboard to provide an egress area within the hospital bed headboard. In this manner, if an emergency occurs during transportation of a patient, immediate access to the patient from the headboard side of the mobile hospital bed is provided to address the patient's emergency condition.

Once the emergency is over, the first panel may close the right side of the hospital bed headboard and the second panel may close the left side of the hospital bed headboard to close the egress area, so that the hospital bed headboard becomes fixed akin to traditional headboards.

In some examples, the hospital bed headboard may include panel shelves or platforms or trays attached to the exterior of the first panel and the second panel. The panel shelves or platforms may be extended to support medical equipment such as a respirator, a ventilator, etc. In this manner, existing equipment and additional equipment can be transported in a compact and efficient manner while utilizing fewer medical staff to manage items during patient transportation. When not in use, the shelves or platforms may be collapsed and stowed away.

In other examples, the hospital bed headboard may include a fixed third panel to protect a patient's head. The third panel is itself positioned below the first panel and the second panel, the third panel extending from a left support to a right support. In one example, the hospital bed headboard may include retractable IV (intravenous) poles positioned within a support of the hospital bed headboard.

Further improvements to the hospital bed headboard include a rechargeable battery system integrated into the headboard body to provide a secondary or backup power source for vital medical equipment like IV pumps during transport or power outages. This system includes charging ports/outlets and a battery life indicator to monitor the power status.

An additional functional improvement is the integration of a secondary, foldable tray into the headboard panels. This tray is designed for day-to-day patient use, such as for food, drinks, and personal belongings (e.g., phone, magazine). This secondary tray, unlike the existing shelves for transport equipment, swivels and folds from a cavity in the panel. The tray is configured to fold in half when stowed and can be deployed with a secondary hinged portion to become wider when fully open.

The tray includes impregnation molding that creates a small indentation for placing a cup or other beverage items, making the headboard more functional for awake and alert patients in a post-critical care or stationary setting. The patient can utilize only one tray or both side trays unfolded simultaneously. When both trays are open, they are configured to maintain a gap in the middle to allow the patient's body to maneuver and to prevent limb or body entrapment.

The tray is also configured to horizontally move (slide or pivot) in its open position such that it can be closer to or farther from the patient's body and may include a power source/port to charge a personal electronic device like a smart telephone.

To improve hospital logistics, the headboard may also incorporate a tracking device, such as a GPS locator, coupled with Bluetooth technology, to allow hospital administration and transport teams to track the exact coordinates of the bed's location and monitor transport efficiency.

### BRIEF DESCRIPTION OF THE DRAWINGS

Examples of the disclosure will be rendered by reference to specific examples which are illustrated in the appended drawings. The drawings illustrate only particular examples of the disclosure and therefore are not to be considered to be limiting of its scope. The principles here are described and explained with additional specificity and detail through the use of the accompanying drawings.

FIG. 1 illustrates a side plan view of a hospital bed headboard attached to a mobile hospital bed according to an example of the present invention;

FIG. 2 illustrates a back perspective view of the mobile hospital bed and the hospital bed headboard of FIG. 1;

FIG. 3 illustrates a front perspective view of the mobile hospital bed with open front panels of the headboard according to an example of the present disclosure;

FIG. 4 is a right corner perspective view of a mobile hospital bed illustrating the panel shelves (platforms) of the headboard according to an example of the present disclosure;

FIG. 5 illustrates an exploded view of the hospital bed headboard of FIG. 1 showing attachment of the first and second panel shelves according to an example of this disclosure;

FIG. 6 illustrates a top back perspective view of the mobile hospital bed of FIG. 1 wherein the hospital bed headboard is insertable or removable in an example of the present disclosure;

FIG. 7 illustrates a perspective view of an upgraded headboard with cavities for the secondary patient-use trays according to an example of the present disclosure;

FIG. 8 illustrates a perspective view of the upgraded headboard of FIG. 7 with the secondary patient-use trays in an open position according to an example of the present disclosure;

FIG. 9 illustrates a perspective view of the upgraded headboard of FIG. 7 showing the deployment and folding mechanism of the secondary patient-use trays according to an example of the present disclosure; and

FIG. 10 illustrates a perspective view of the upgraded headboard detailing the oxygen tank holder, charging ports, and battery indicator according to an example of the present disclosure.

### DETAILED DESCRIPTION

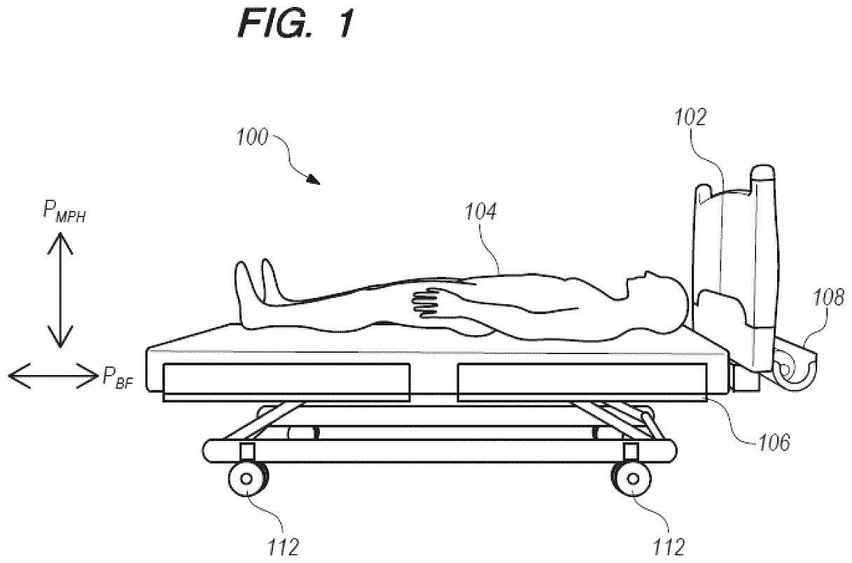

FIG. 1 illustrates a side plan view of a hospital bed headboard 102 attached to a mobile hospital bed 100 according to an example of the present invention. In this example, mobile hospital bed 100 can facilitate the transportation of a patient 104 from one hospital unit to another unit such as when a medical procedure is needed by patient 104.

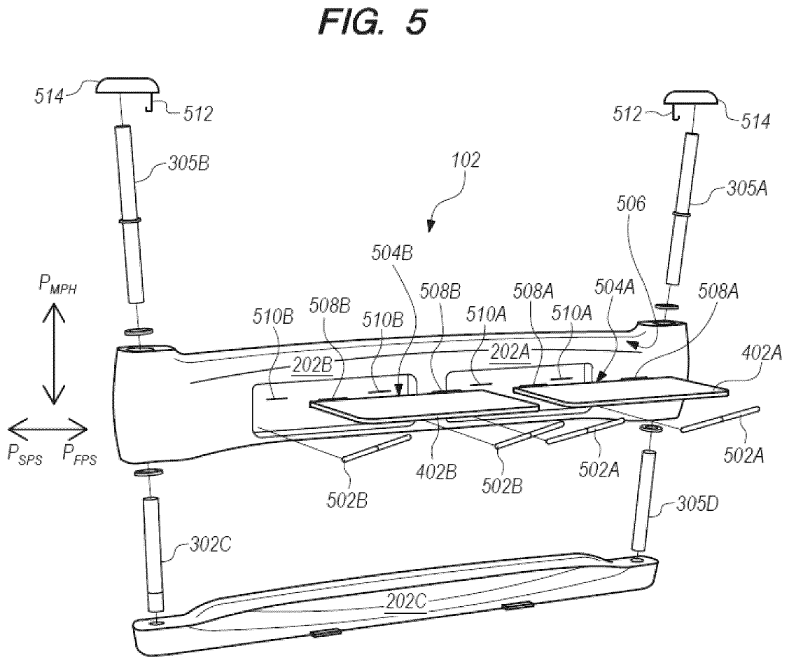

Here, the hospital bed headboard 102 may be planar and multipaneled. As such, in this disclosure, the hospital bed headboard 102 may be interchangeably referred to as planar multiple paneled headboard 102. As used herein, the term “planar” refers to a two-dimensional feature where a third dimension, if any, is insubstantial relative to other dimensions of the feature. By “multiple paneled,” it is meant that hospital bed headboard 102 has plural distinct panels such as first panel 202A and second panel 202B that are not attached to each other. The first panel 202A may be positioned adjacent to the second panel 202B. (See FIG. 5 below for an illustration of the hospital bed headboard 102 by itself (without the mobile hospital bed 100)).

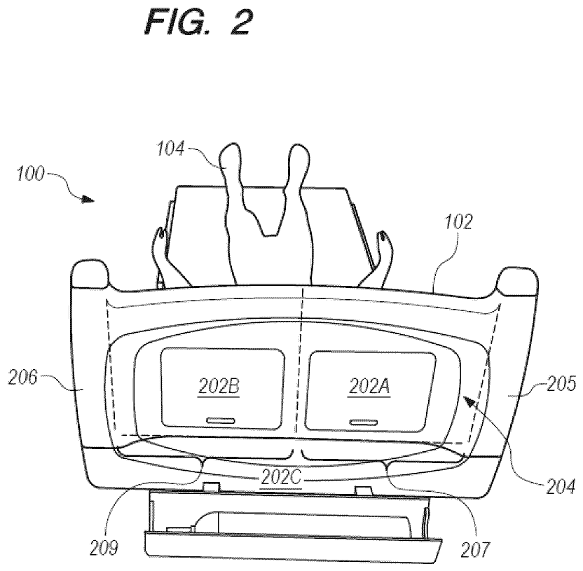

Referring now to FIG. 2, which is a back-perspective view of the mobile hospital bed 100 and hospital bed headboard 102 showing a distal end 204 of the first panel 202A. The distal end 204 may be pivotally attached at intersection 211 to a corresponding right end support 205. As used here, “pivotally attached” may include attachment devices such as butt hinges, pivot hinges, etc. In this manner, first panel 202A may open a right side 207 of the hospital bed headboard 102. Similarly, an oppositely disposed distal end 206 of the second panel 202B is pivotally attached at an intersection 212 to a left end support 208. In this manner, second panel 202B may open a left side 209 of the hospital bed headboard 102.

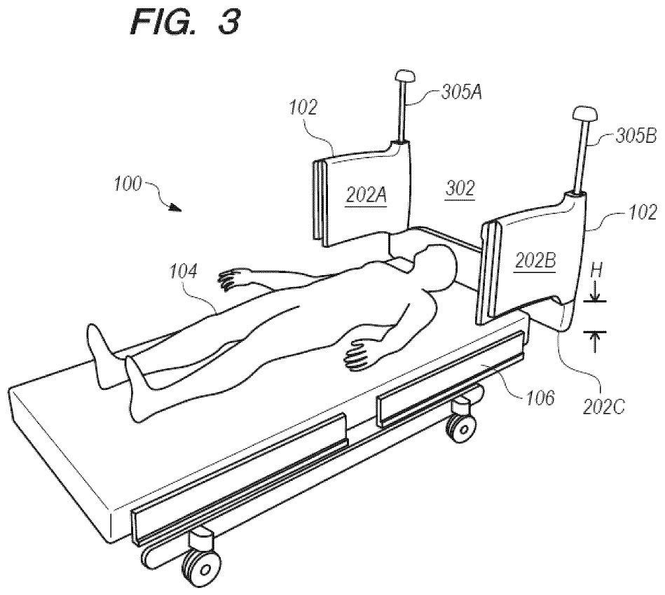

In short, the first panel 202A opens the right side 207 of the hospital bed headboard 102 and the second panel 202B opens the left side 209 of the hospital bed headboard 102 to provide an egress 302 (shown in FIG. 3) for the hospital bed headboard 102.

As such, if an emergency exists and quick access to the patient becomes necessary during patient transportation, first panel 202A and second panel 202B can be opened-inwardly toward patient 104 to immediately access patient 104 from the headboard end of mobile hospital bed 100. For example, during patient transportation, if patient 104 suddenly begins to choke, first and second panels 202A and 202B can be immediately opened to access patient 104 via egress 302 and to treat the choking condition thus saving the patient's life.

Once the headboard is open, it allows quick life-saving access to the patient's head. Clinicians may easily assess the patient's neurological and respiratory status quickly. When the emergency is over, the first panel 202 closes the right side 207 of the hospital bed headboard 102 and the second panel 202B closes the left side 209 of the hospital bed headboard 102 so as to close the entirety of the egress 302 in the hospital bed headboard 102. In one example, hospital bed headboard 102 may be akin to double doors that can be swung open and can then be closed to form a single headboard once the emergency is over.

In FIG. 2, hospital bed headboard 102 may include a third panel 202C positioned below the first panel 202A and the second panel 202B. Third panel 202C may be fixed and may extend from the right end support 205 to the left end support 208 (or substantially from distal end 206 to the distal end 204). The third panel 202C can protect the head of patient 104 while lying on mobile hospital bed 100. As shown in the example of FIG. 3, the height H of third panel 202C is of sufficient height to extend from the bottom to the top of the head of patient 104 (while lying on mobile hospital bed 100) to prevent objects or hospital staff from making accidental contact with the head of patient 104.

In some examples, the hospital bed headboard 102 may be part of mobile hospital bed 100 at the time of manufacture. In other examples, the hospital bed headboard 102 may replace existing hospital bed headboards on a mobile hospital bed. In which case, once the existing headboard is disengaged, the hospital bed headboard 102 can be attached to the frame of the mobile hospital bed via screws or other attachment mechanisms.

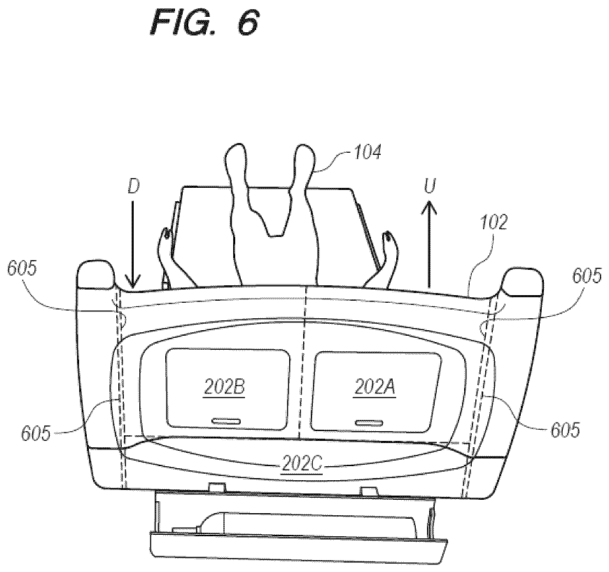

In some examples, as shown in FIG. 6, first panel 202A, second panel 202B and third panel 202C are designed to insert into mobile hospital bed 100 as a single unit. The panels as a single unit may be inserted downward along a direction D to slide the panels along slot 602 until the entirety of the panels is engaged. Specifically, the first panel 202A and the second panel 202B may be pivotally or hingedly attached to a male end 605 and along with third panel 202C can slide into slot 602. Likewise, first panel 202A, second panel 202B and third panel 202C may be disengaged from the mobile hospital bed 100 as a single unit by sliding upwards in the U direction along slot 602.

In this manner, with the above examples, the hospital bed headboard 102 is adaptable and may be installed or disengaged from existing mobile hospital beds.

In one example, the width of hospital bed headboard 102 is 42″ inches. In some examples, dimensions of hospital bed headboard 102 are compatible with all major bed manufacturers including Hillrom™ and Stryker™. Other suitable dimensions may be employed. Hospital bed headboard 102 may be constructed from a variety of suitable materials. For example, hospital bed headboard 102 may be made of a polymeric material. Other materials may be wood, metal or any material consistent with the spirit and scope of the present disclosure.

Referring now to FIG. 1, mobile hospital bed 100 further includes a bed frame 106 connected to the hospital bed headboard 102. A plane of the bed frame P_{BF} extends latitudinally and is substantially perpendicular to a plane P_{MPH} of the planar multiple paneled headboard that extends in a longitudinal direction. Mobile hospital bed 100 also includes an oxygen tank holder 108 and legs 110 attached to an underside of bed frame 106 to support the bed frame 106 and wheels 112 to attach to legs 110. The configuration of the frames and legs is but an example, and other configurations may be utilized. For example, legs 110 may be directly coupled from bed frame 106 to wheels 112.

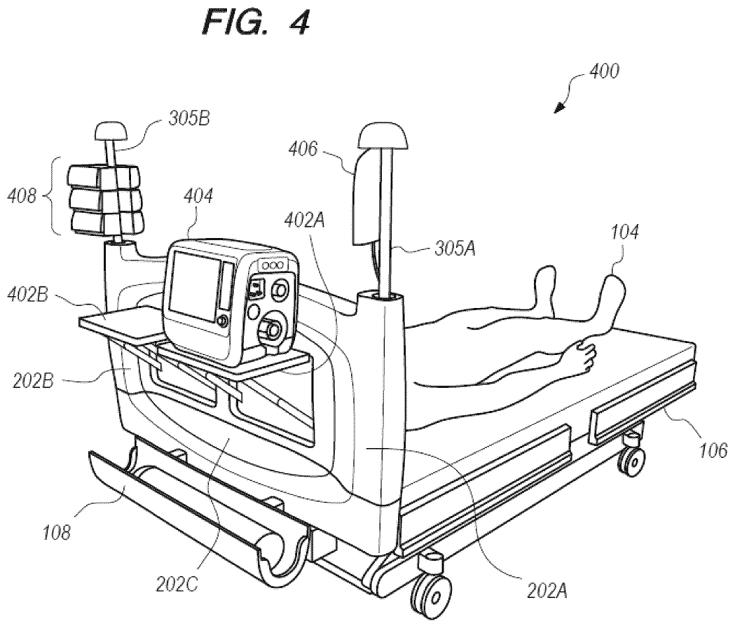

FIG. 4 is a right corner perspective view of a mobile hospital bed 400 illustrating the panel shelves (platforms) of the hospital bed headboard 102 according to an example of the present disclosure. In this example, mobile hospital bed 400 includes plural panel shelves (platforms) including a first panel shelf or platform 402A and a second panel shelf or platform 402B.

Each one of the first panel shelf 402A and the second panel shelf 402B may support medical equipment used by or attached to patient 104. As can be seen in FIG. 4, second panel shelf 402B is supporting a ventilator 404. Although not shown, other types of medical equipment may be supported. By supporting medical equipment on shelves attached to the headboard, separate stands for medical equipment, which can be cumbersome, need not be employed. Moreover, existing equipment and additional equipment can be transported in a compact and efficient manner while utilizing fewer medical staff to manage items during patient transportation.

In FIG. 4, IV poles 305A and 305B are also shown. Each one of IV pole 305A and 305B is retractable as further illustrated in FIG. 5. In this example, IV pole 305A may hang an intravenous bag 406. In other examples, IV pole 305B may hold pumps 408 for delivering medication to patient 104 (FIG. 1). The items on the IV poles 305A and 305B may be held by anchors 512 (FIG. 5), which anchors 512 may be concealed by caps 514. In this manner, free standing poles that would ordinarily hold medical equipment separate and apart from medical hospital bed 100 are eliminated. Although not shown, IV poles 305A and 305B may hold other medical devices or equipment.

FIG. 5 illustrates an exploded view of hospital bed headboard 102 showing attachment of the first and second panel shelves 402A and 402B. In one example, when first panel shelf 402A is extended to support medical equipment, a front edge 504A of the first panel shelf 402A is attached to an exterior side 506 of the first panel 202A.

Specifically, front edge 504A of first panel shelf 402A and the first panel 202A are attached via a male lip 508A that mates with a corresponding female opening 510A. Second panel shelf 402B and second panel 202B are also attached via a male lip 508B that mates with female opening 510B. It is noted that a plane P_{FPS} of first panel shelf 402A is disposed latitudinally to the plane P_{MPH} of hospital bed headboard 102. Similarly, plane P_{SPS} of second panel shelve 402B is disposed latitudinally to the plane P_{MPH} of hospital bed headboard 102.

In addition, when first panel shelf 402A is extended as in FIG. 5, a pair of brackets 502A can be extended to lock first panel shelf 402A in place while another pair of brackets 502B can be extended to lock second panel shelf 402B in place. Conveniently, when first panel shelf 402A and second panel shelf 402B are not in use, the pair of brackets 502A and 502B may be unlocked to collapse first and second panel shelves 402A and 402B and to stow first and second panel shelves 402A and 402B to be flush with planar multiple paneled headboard 102.

FIG. 5 also illustrates an exploded view of IV poles 305A and 305B. Each one of IV poles 305A and 305B is retractable. Specifically, IV pole 305A may retract in its entirety into a base IV pole 305D while IV pole 305B may retract in its entirety into base IV pole 305C.

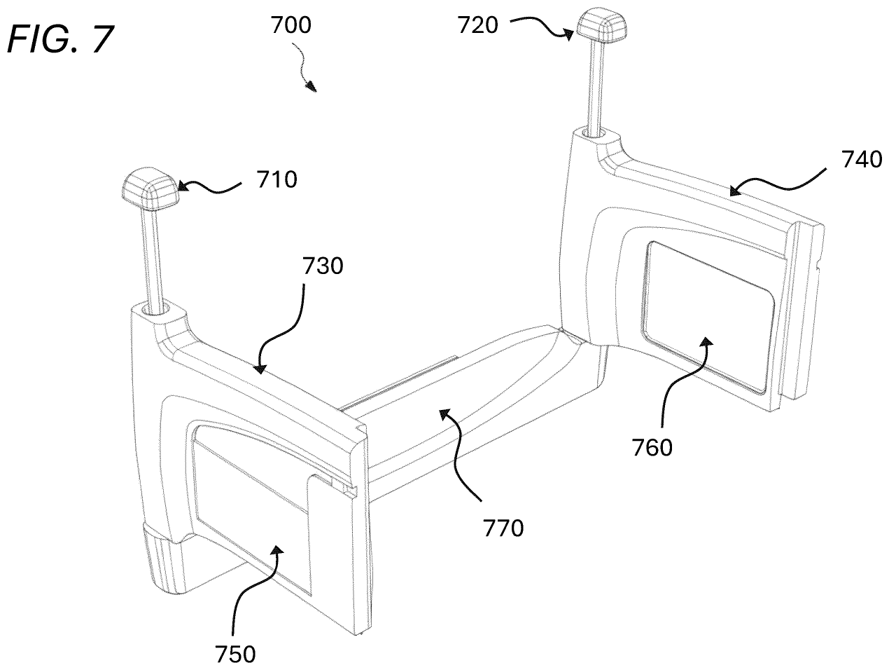

While FIGS. 1-6 provide some embodiments of the disclosure, FIGS. 7-10 introduce additional embodiments that include features that enhance the functionality of the hospital bed headboard, particularly for post-critical care and transport logistics. It is to be understood that the headboard illustrated in FIGS. 7-10, generally designated as 700, 800, 900, and 1000, is coupled to the same type of mobile hospital bed 100 with the bed frame 106 and wheels 112 as shown in FIGS. 1-6. The overall structure, including the capability for a patient egress area via the panels and the retractable IV poles, is retained.

FIG. 7 illustrates a perspective view of an upgraded headboard with cavities for the secondary patient-use trays according to an example of the present disclosure. As depicted in FIG. 7, a headboard 700 with supports 710 and 720 (which may house the retractable IV poles) and panels 730 and 740 (corresponding to the first and second panels 202A/202B) is part of the hospital bed. Unlike the equipment shelves 402A/402B for ventilators, these panels now include recessed cavities or indentations 750 and 760 on the side facing the patient, which are designed to house a secondary, foldable bedside tray. The trays are for non-critical day-to-day patient use, such as for holding food, drinks, or personal items.

In some embodiments, one of the structural feature of the secondary trays is their foldability, which allows them to be completely stowed within the relatively thin panels (730, 740). To achieve this, the first foldable tray (850) and the second foldable tray (860) are designed to be folded into a bi-fold configuration when returned to their concealed position, thereby fitting flush within the cavities (830, 840). The trays are specifically designed for patient use, with an impregnation molding that creates a recessed area or indentation for securing a beverage container, preventing spills during use. Furthermore, the trays are configured for independent use, meaning a patient may deploy only the first foldable tray (850) or only the second foldable tray (860), or both simultaneously, to accommodate various activities.

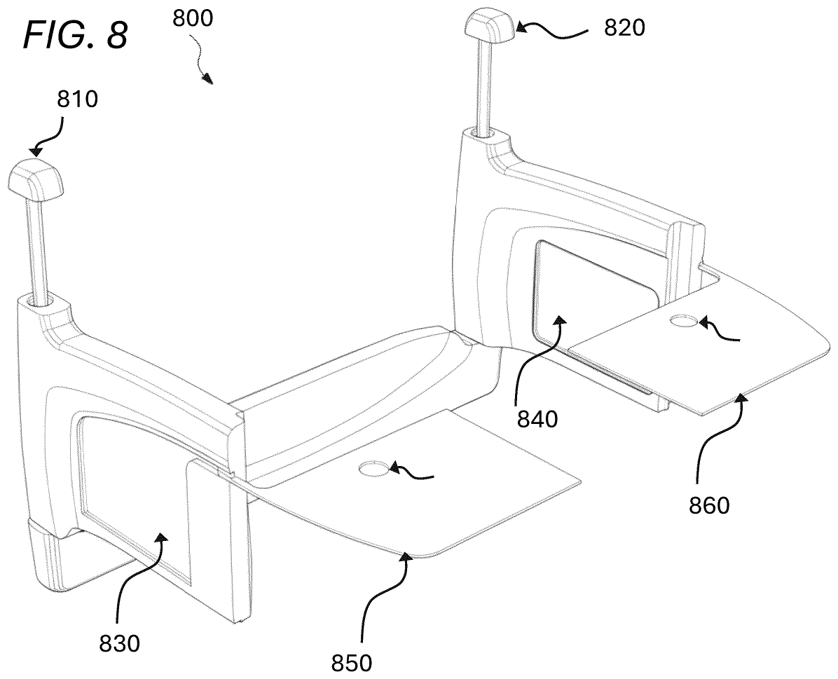

FIG. 8 illustrates a perspective view of the upgraded headboard of FIG. 7 with the secondary patient-use trays in an open position according to an example of the present disclosure. As depicted, the headboard 800 with these secondary patient-use trays is shown as deployed into an open position. Tray 850 is shown deployed from cavity 830, and tray 860 is shown deployed from cavity 840. These trays function as a replacement for the traditional standalone bedside table, providing a convenient, integrated surface for the patient 104 while they are awake and perhaps sitting up in bed. Both trays are designed to be approximately the same size, reflecting the dimensions of the cavity in which they are concealed. They can be used individually or simultaneously.

Tray 850 and Tray 860 are configured to remain in a substantially fixed vertical position relative to the headboard once deployed, though their horizontal position is adjustable via the folding/swiveling mechanism. The trays are designed with impregnation molding (not explicitly numbered but implied by the shape and function) to provide a small indentation or recess to help hold items like cups and other beverage containers, preventing them from freely sliding back and forth during patient use. Additionally, the trays may include a power port (such as a USB or other small charging outlet) to allow the patient to charge personal electronic devices like a smart telephone.

The multiple trays (850, 860) can be secured in their concealed position using a latch mechanism. This latch may be a simple press-fit mechanical mechanism, a screw mechanism, or a slider that locks and unlocks the trays. Alternatively, an electronic latching mechanism may be employed. When the electronic mechanism is used, a motor and gear assembly housed within the headboard body (1080) provides the motion to unlatch the lock and, optionally, to deploy the trays. A patient may be provided with a remote control or a button on the headboard to trigger this function. For example, a patient can press a button to manually unlatch the lock and swivel the trays open, or press an electronic button which activates the motor to automatically unlatch and bring the tray forward. While various latching and locking mechanisms are described, the embodiments are not so limited, and other suitable locking mechanisms may also be used.

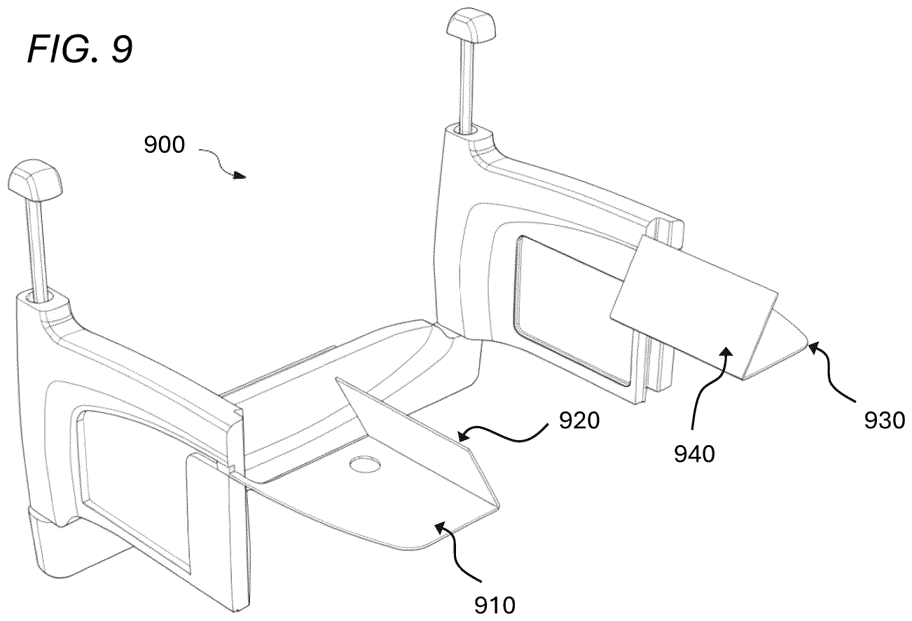

FIG. 9 illustrates a perspective view of the upgraded headboard of FIG. 7 showing the deployment and folding mechanism of the secondary patient-use trays according to an example of the present disclosure. The tray 910 depicted is shown in a fully deployed position. The tray swivels open and then may include a secondary folding portion 920 that expands the surface area, making it wider than the space in the cavity. Tray 940 is shown partially deployed or beginning to fold out from its cavity, demonstrating its hinging or swivel connection. When both trays are fully open, they are positioned to meet in the middle (like 910 and the corresponding open tray on the other side) but are designed to intentionally leave a gap between them. This gap ensures patient safety by preventing the trays from fully locking in the patient, eliminating the risk of accidental limb or body part entrapment, which is a key design consideration in the medical world. The tray folds back onto itself like a piece of paper along a horizontal part attached to the door, hinges, and then flips down (or swivels) back into the molding of the door for concealment.

The trays (910, 940) may be configured to fold into a bi-fold (folding in half) or a tri-fold configuration when stowed, allowing them to expand significantly when deployed. Even within a fold, the tray may incorporate mechanisms to horizontally displace a portion of the tray, allowing sections to slide with respect to one another. For example, a first portion of the deployed tray may be one foot away from the patient, but a hinge or slider mechanism may allow the patient to pull the second and third portions of the tray closer—less than one foot away—where they can be locked into position. For hands-free operation, the hospital bed may be equipped with voice recognition technology. A patient can issue a command, such as “bring the trays forward,” which activates the electronic latch and motor to automatically deploy the trays. Furthermore, the system may employ pattern-learning machine technology to allow a patient to program and save memory settings for the trays' displacement. For instance, Setting 1 could be programmed for a reclined position, and Setting 2 for a sitting-up position. Upon selecting a memory setting, the motor would automatically push the trays forward until they reach the saved distance from the patient, stopping precisely at the desired position.

In some embodiments, the memory system further incorporates a sophisticated pattern learning machine technology. This machine is designed to automatically learn and record the patient's habitual preferences. For instance, if the patient repeatedly pulls or adjusts the trays to a specific deployment distance (closer or farther) more than a pre-determined number of times, the system may automatically recognize this position as a preferred setting and store it as a new memory setting (e.g., Setting 3). This automatic learning capability ensures the trays are consistently deployed to the patient's preferred distance based on their established pattern of use, optimizing patient comfort without requiring explicit programming by the patient or staff.

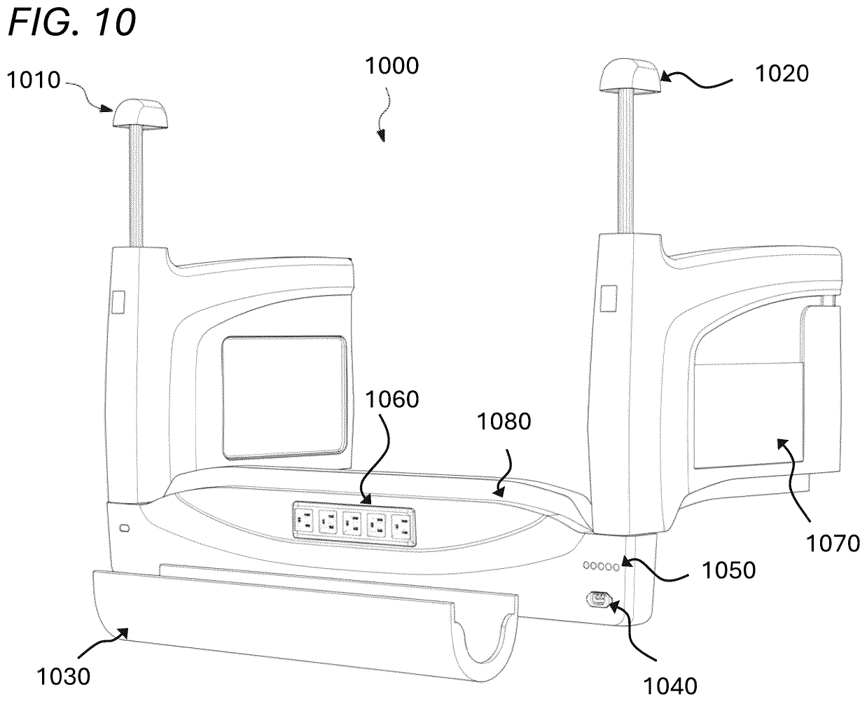

FIG. 10 illustrates a perspective view of the upgraded headboard detailing the oxygen tank holder, charging ports, and battery indicator according to an example of the present disclosure. FIG. 10 illustrates the headboard 1000 from a rear perspective (facing away from the patient) to detail the integrated charging and oxygen features. The headboard 1000 includes a semi-cylindrical recess 1030 at the base, which serves as a secure oxygen tank holder during patient transport. The tank rests in this recess, preventing it from having to be laid on the bed or secured in a less stable manner.

The headboard also incorporates a dedicated electrical system for critical equipment during transport. The body 1080 of the headboard (which may correspond to the third panel 202C) houses a rechargeable battery (not explicitly numbered but implied to be within 1080) to act as an auxiliary or backup power source for vital medical equipment, addressing potential power shortages during long transports or power outages. Outlets 1060 (such as standard AC outlets) are provided, allowing IV pumps 408 or other electronic medical equipment to be plugged directly into the headboard.

A port 1040 is included on the headboard body to allow the internal rechargeable battery to be charged from a standard wall power outlet. The indicator lights 1050 provide a visual signal of the remaining battery life of the headboard's internal power source, enabling medical staff to monitor and manage the power available during transport. The headboard's charging feature is designed to be intelligent: it may conserve its own battery power until the battery of an attached device (like an IV dispensing machine) falls below a predefined threshold (e.g., 50%), at which point the headboard's power source automatically kicks in.

The integrated power system, as described above, consists of the rechargeable battery and charging circuit, and is designed for intelligent power management to maximize efficiency during transport. The charging circuit is configured to monitor the battery status of any external medical device (such as IV pumps) plugged into the electrical outlets (1060). The system may remain dormant or conserve its charge until the medical device's battery falls below a predefined threshold, such as fifty percent (50%), at which point the headboard's rechargeable battery automatically activates and begins supplying power to the device via the charging ports. To support advanced logistics, the internal bed locator is a GPS locator configured to provide the coordinates of the mobile hospital bed's physical location, allowing transport teams and administrators to accurately track its position in real time. This GPS locator also utilizes Bluetooth technology to ensure secure and efficient communication of location and status data to the hospital's centralized transport management system

Finally, the headboard 1000 is further improved with a GPS locator/tracker (not explicitly numbered but implied to be internally housed), coupled with Bluetooth technology, to enable transport administrators and logistics staff to track the exact location of the mobile bed in real-time. This feature improves internal data collection, monitoring of transport efficiency, and overall asset management within the hospital.

While the above is a complete description of specific examples of the disclosure, additional examples are also possible. Thus, the above description should not be taken as limiting the scope of the disclosure which is defined by the appended claims along with their full scope of equivalents.

What we claim is:

1. A hospital bed headboard system for a mobile hospital bed, the headboard being attached to a bed frame of the mobile hospital bed, the system comprising:
a planar multiple paneled headboard including a first panel and a second panel, wherein the first panel and the second panel are pivotally attached to corresponding supports and are configured to swing open inwardly toward a patient supported by the mobile hospital bed to provide an egress area;
a first cavity and a second cavity respectively disposed in a patient-facing side of the first panel and the second panel;
a first foldable tray concealed within the first cavity, the first foldable tray configured to swivel from the first cavity and into an open position; and
a second foldable tray concealed within the second cavity, the second foldable tray configured to swivel from the second cavity and into an open position, wherein the first and second foldable trays in their open position provide a patient-accessible surface, and re configured to return to a fully concealed and locked position within their respective cavities.

2. The hospital bed headboard system of claim 1, wherein the first foldable tray includes an impregnation molding configured to provide an indentation for securing a liquid container on the patient-accessible surface.

3. The hospital bed headboard system of claim 1, wherein the first foldable tray is configured to be folded in half when returned to the fully concealed position within the first cavity.

4. The hospital bed headboard system of claim 1, wherein each of the first and second foldable trays includes a secondary hinged portion, the secondary hinged portion configured to expand the surface area of the tray when fully opened.

5. The hospital bed headboard system of claim 1, wherein the first and second foldable trays, when both are in the open position, are configured to maintain a non-zero gap between them to allow for patient body maneuverability and to prevent patient entrapment.

6. The hospital bed headboard system of claim 1, wherein the first and second foldable trays are configured to be used independently of each other.

7. The hospital bed headboard system of claim 1, wherein the first foldable tray, in the open position, is configured to horizontally move such that it can be adjusted to be closer to or farther from the patient's body.

8. The hospital bed headboard system of claim 1, further comprising a locking mechanism configured to secure the first foldable tray in the fully concealed position within the first cavity.

9. The hospital bed headboard system of claim 1, further comprising an integrated power system housed within the headboard body, the integrated power system including a rechargeable battery.

10. The hospital bed headboard system of claim 9, further comprising a plurality of electrical charging ports disposed on an exterior surface of the headboard and electrically coupled to the integrated power system, the ports configured to supply power to an external medical device.

11. The hospital bed headboard system of claim 9, further comprising a power indicator coupled to the integrated power system for visually displaying a charge level of the rechargeable battery.

12. The hospital bed headboard system of claim 9, wherein the integrated power system is configured to supply power from the rechargeable battery when a battery of an attached medical device falls below a predefined threshold.

13. The hospital bed headboard system of claim 1, further comprising a personal charging port coupled to the headboard's power source and disposed on at least one of the first and second foldable trays for charging a personal electronic device.

14. The hospital bed headboard system of claim 1, further comprising a GPS locator integrated into the headboard for tracking the physical location and providing the coordinates of the mobile hospital bed.

15. The hospital bed headboard system of claim 14, wherein the GPS locator is coupled with Bluetooth technology for communicating location data to a transport management system.

16. The hospital bed headboard system of claim 1, further comprising a semi-cylindrical recess disposed at a base of the headboard, the recess configured to securely hold an oxygen tank during transport.

17. The hospital bed headboard system of claim 1, wherein the first panel and the second panel are configured to provide an egress area for quick access to the patient's head when swung open.

18. The hospital bed headboard system of claim 1, further comprising a fixed third panel positioned below the first panel and the second panel to protect a patient's head.

19. The hospital bed headboard system of claim 1, further comprising a first retractable intravenous pole and a second retractable intravenous pole positioned within supports of the headboard.

20. The hospital bed headboard system of claim 1, wherein the first foldable tray is configured to:
enter maintain a tri-fold configuration when concealed within the first cavity; and
utilize a sliding mechanism in the open position to allow a first portion of the tray to remain at a fixed distance from the patient and a second portion of the tray to be manually pulled closer to the patient and locked at a second, closer distance.
